(19) United States
(12) Patent Application Publication
(10) Pub. No.: US 2025/0184767 A1
(43) Pub. Date: Jun. 5, 2025

(54) OPTIMIZATION NODE AND METHOD IN A WIRELESS COMMUNICATIONS NETWORK

(71) Applicant: Telefonaktiebolaget LM Ericsson (publ), Stockholm (SE)

(72) Inventors: Alexey SHAPIN, Luleå (SE); Hideshi MURAI, Zushi (JP); Leefke GROSJEAN, Täby (SE); Peter DE BRUIN, Gammelstad (SE); Swarup KUMAR MOHALIK, Bangalore (IN)

(21) Appl. No.: 18/844,720

(22) PCT Filed: Mar. 8, 2022
(86) PCT No.: PCT/SE2022/050226

§ 371 Date: Sep. 6, 2024

(51) Int. Cl. H04W 24/02; H04W 16/18; H04W 24/08

(52) U.S. Cl. CPC H04W 24/02; H04W 16/18; H04W 24/08

(57) ABSTRACT

A method performed by an optimization node for optimizing network performance in a wireless communications network. The optimization node obtains measurement data related to the performance of the communications network. The measurement data comprises corresponding location information. A three-dimensional coverage map is generated based on the obtained measurement data that indicates the performance of the wireless communications network in the coverage map area. The optimization node detects, based on the generated coverage map, locations suffering from a degraded performance in relation to a performance requirement. The optimization node estimates a configuration for optimizing network performance, taking the performance requirement into account. The configuration comprises one or more parameters for restraining the influence of the performance degradation. The estimated configuration is evaluated by performing at least one of a first and a second action for optimizing network performance, taking the estimated configuration and performance requirement into account.

### TECHNICAL FIELD

Embodiments herein relate to an optimization node method therein. Furthermore, a computer program and a computer readable storage medium are also provided herein. In particular, embodiments herein relate to optimizing network performance in a wireless communications network.

### BACKGROUND

In a typical wireless communication network, wireless devices, also known as wireless communication devices, mobile stations, stations (STA) and/or User Equipments (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as a UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

In indoor wireless deployments it is crucial to place base station antennas correctly to ensure good coverage and consequently optimize capacity of the wireless communications network.

### SUMMARY

An object of embodiments herein is to improve the flexibility and performance of a wireless communications network.

According to an aspect of embodiments herein, the object is achieved by a method performed by an optimization node for optimizing network performance in a wireless communications network. The wireless communications network comprises one or more base stations. The one or more base stations provides radio coverage in a wireless communications network. The optimization node obtains measurement data related to the performance of the wireless communications network. The measurement data comprises location information associated to each respective measurement in the measurement data. The optimization node generating a three-dimensional coverage map based on the obtained measurement data. The coverage map indicates the performance of the wireless communications network in the area covered by the coverage map. The optimization node detects, based on the generated coverage map, one or more locations suffering from a degraded performance in relation to a performance requirement. The optimization node estimates a configuration for optimizing the network performance. The configuration comprises one or more parameters for restraining the influence of the performance degradation. The optimization node evaluates the estimated configuration by performing at least one of a first and a second action for optimizing network performance, taking the estimated configuration into account.

According to another aspect of embodiments herein, the object is achieved by an optimization node configured to optimize network performance in a wireless communications network. The wireless communications network is adapted to comprise one or more base stations. The one or more base stations are adapted to provide radio coverage in the wireless communications network. The optimization node is further configured to obtain measurement data adapted to be related to the performance of the wireless communications network. The measurement data is adapted to comprise location information associated to each respective measurement in the measurement data. The optimization node is further configured to generate a three-dimensional coverage map adapted to be based on the obtained measurement data. The coverage map is adapted to indicating the performance of the wireless communications network in the area covered by the coverage map. The optimization node is further configured to detect, based on the generated coverage map, one or more locations suffering from a degraded performance in relation to a performance requirement. The optimization node is further configured to estimate a configuration adapted to optimize the network performance. The configuration is adapted to comprise one or more parameters adapted to restrain the influence of the performance degradation. The optimization node is further configured to evaluate the estimated configuration by performing at least one of a first and a second action adapted to optimize network performance, taking the estimated configuration into account.

It is furthermore provided herein a computer program comprising instructions, which, when executed on at least one processor, cause the at least one processor to carry out the method above, as performed by the optimizing node. It is additionally provided herein a computer-readable storage medium, having stored thereon a computer program comprising instructions which, when executed on at least one processor, cause the at least one processor to carry out the method according to the method above, as performed by the optimizing node.

Since the optimization node obtains measurement data related to the performance of the wireless communications network, it is possible for the optimization node to generate the three-dimensional coverage map. Based on the generated coverage map, the optimization node detects one or more locations suffering from a degrading performance, estimates a configuration restraining the performance degradation for optimizing the network performance. The optimization node evaluates the estimated configuration by at least one of a first and a second action, taking the estimated configuration into account. In this way an efficient mechanism for optimizing the network performance is achieved, which in turn results in an improved flexibility and performance of the wireless communications network.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a flowchart depicting embodiments of a method in an optimization node.

FIG. 3a-b are schematic block diagrams illustrating embodiments of a management node.

FIG. 4 schematically illustrates a telecommunication network connected via an intermediate network to a host computer.

FIG. 5 is a generalized block diagram of a host computer communicating via a base station with a user equipment over a partially wireless connection.

FIGS. 6-9 are flowcharts illustrating methods implemented in a communication system including a host computer, a base station and a user equipment.

### DETAILED DESCRIPTION

As a part of developing embodiments herein a problem was first identified and will be discussed herein.

In factory or industry deployments, many User Equipment's (UEs) are often stationary, and selecting the best location for these UEs would also be important for optimal network performance/capacity, for instance to avoid interference or poor radio coverage. When moving or adding equipment in a factory it is crucial to identify potentially newly created “blind spots” with poor network coverage. Metrics such as interference, line of sight, signal strength, pathloss may be derived by different tools in two or three dimensions. However, three-dimensional maps are quite difficult to use in a maintenance process when changing a placing of antenna/UE. This may lead to a decreased and/or poor flexibility in the wireless communications network, resulting in a degraded performance in the wireless communications network. An object of embodiments herein is to improve the flexibility and performance of a wireless communications network.

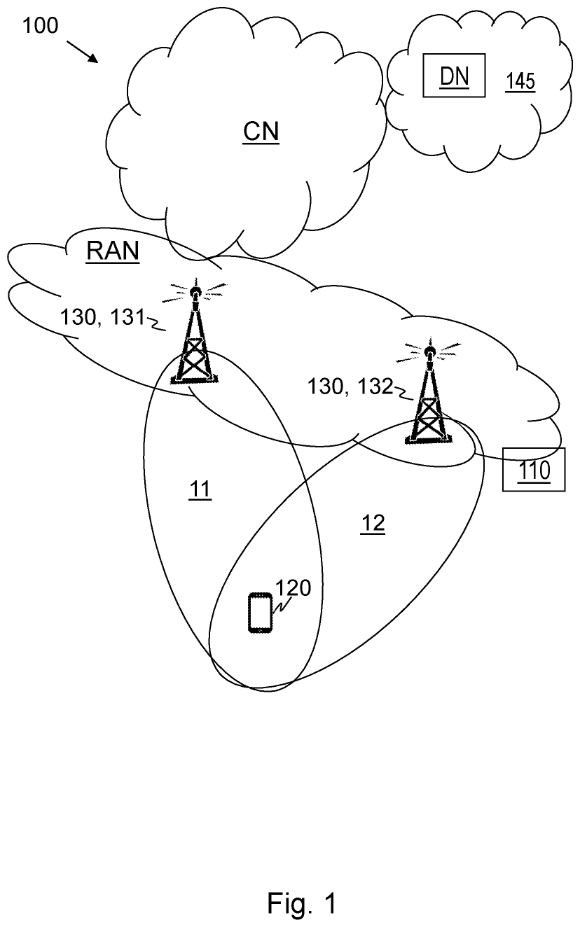

FIG. 1 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the wireless communications network 100 such as e.g., an optimization node 110. Further, a number of base stations such as e.g. a first base station 131 and a second base station 132, also referred to as the base stations 130, also operate in the wireless communications network 100. The base stations may be associated to the optimization node 110. The base stations 131, 132, and in some embodiments the optimization node 110 provide radio coverage in a number of coverage areas in a cell, e.g. to a wireless device 120, such as a coverage area 11 provided by the first base station 131 and a coverage area 12 provided by the second base station 132. The optimization node 110 may control the base stations 131, 132. The optimization node 110 may be a base station, e.g. the first base station 131, or a stand-alone server or base station. The optimization node 110, and the base stations 130 may each be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a terminal within the service area served by the optimization node 110 depending e.g. on the first radio access technology and terminology used. The optimization node 110 may be implemented in a serving radio network node, such as the first base station 131 or the second base station 132, that communicates with the wireless device 120 with Downlink (DL) transmissions to the wireless device 120 and Uplink (UL) transmissions from the terminal 120.

In the wireless communication network 100, one or more wireless devices operate, such as e.g. the wireless device 120. The wireless device 120 may also referred to as a device, a terminal, an IoT device, a robot, a mobile station, a non-access point (non-AP) STA, a STA, a user equipment and/or a wireless terminal, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

Methods herein may be performed by the optimization node 110. As an alternative, a Distributed Node (DN) and functionality, e.g. comprised in a cloud 145 as shown in FIG. 1, may be used for performing or partly performing the methods herein.

A number of embodiments will now be described, some of which may be seen as alternatives, while some may be used in combination.

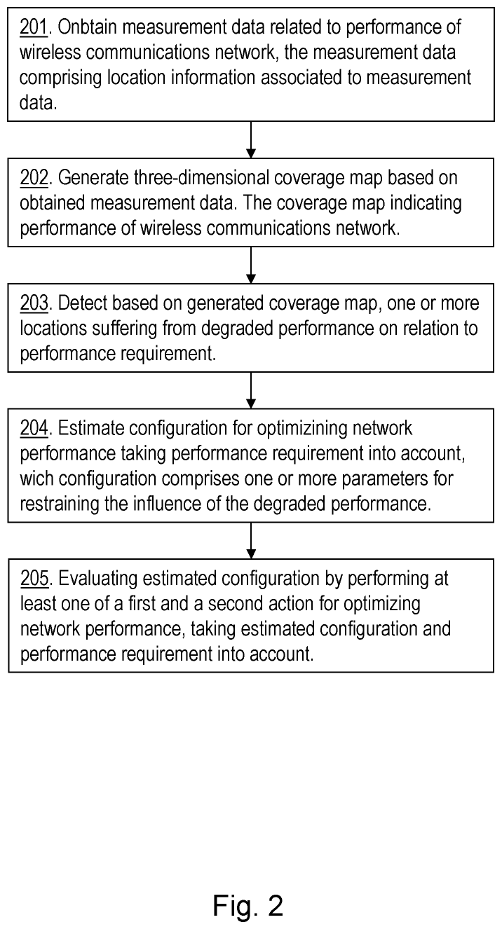

FIG. 2 shows example embodiments of a method performed by the optimization node 110 for optimizing network performance in the wireless communications network 100. The wireless communications network 100 comprises one or more base stations 130. The one or more base stations 130 provides radio coverage in the wireless communications network 100. The method comprises the following actions, which actions may be taken in any suitable order. Optional actions are referred to as dashed boxes in FIG. 2.

Action 201. Measurement data may provide the optimization node 110 with information about the status of the wireless communications network 100. The optimization node 110 obtains measurement data related to the performance of the wireless communications network. The measurement data comprises location information associated to each respective measurement in the measurement data. The measurements in the measurement data may e.g. be measurement of signals transmitted in the wireless communications network 100. The location associated to a measurement in the measurement data may e.g. be the location of the wireless device performing the measurement and/or the location of the wireless device transmitting and/or receiving the measured signal. In some embodiments, the measurement data further comprises data related to any one or more out of: latency of transmissions, bitrate of transmissions, network capacity, and retransmission of data. This may mean that for each measurement in the measurement data, there are more than one measurement value obtained, such as the examples above. This may allow more accurate analysis of the radio coverage.

Action 202. As mentioned above, the obtained measurement data provides the optimization node 110 with the status of the wireless communications network 100. This allows the optimization node 110 to generate a coverage map. The optimization node 110 generates a three-dimensional coverage map based on the obtained measurement data. The coverage map indicates the performance of the wireless communications network 100 in the area covered by the coverage map. The coverage map may be generated based on more than one data for each measurement and location, e.g. data related latency of transmissions, bitrate of transmissions, network capacity, and retransmission of data. This may improve the accuracy of the coverage map, and may further result in an increased flexibility when generating the coverage map, since different types of data may be used when generating the coverage maps.

Action 203. The optimization node 110 detects, based on the generated coverage map, one or more locations suffering from a degraded performance in relation to a performance requirement. A degraded performance may mean that the performance is does meet a pre-defined performance criterium, such as the performance requirement. The optimization node 110 may detect the degraded performance evaluating the coverage map taking the performance requirement into account. In other words, the optimization node 110 may detect that, at a certain location, the performance does not meet the pre-defined performance requirement. The performance requirement may comprise more than one requirement. In some embodiments, the performance requirement comprises any one or more out of: a latency requirement, a latency variation and/or jitter requirement, bit-rate requirement, a capacity requirement, retransmission requirement, e.g. a retransmission occurrence requirement, and a signal strength requirement. This may mean that the optimization node 110 checks, such as evaluates, the performance in relation to more than one performance requirement. In some case the performance is considered to be degraded when one or more performance requirement is not met. In other cases, the performance is considered to be degraded when none of the performance requirements are met. The performance may be considered to be degraded when some combinations of performance requirements are not met, but not degraded when other combinations of performance requirements are not met. A latency requirement may e.g. mean that the latency of transmissions does not exceed a latency threshold. A bit-rate requirement may e.g. mean that the bit-rate for transmissions always are be above a bit-rate threshold, e.g. a minimum bit-rate requirement. A capacity requirement may e.g. mean that the total amount data transmissions, e.g. the number of transmissions and/or the data volume of the transmissions, the wireless communications network 100 can handle exceeds a capacity threshold, e.g. a minimum capacity requirement. A retransmission requirement may e.g. mean that the number of retransmissions does not exceeds a retransmission threshold, e.g. a maximum retransmission requirement. A signal strength requirement may e.g. mean that the signal strength, such a received signal strength, is above a signal strength threshold, e.g. a minimum signal strength requirement.

Action 204. In order to restrain the influence of the performance degradation, a new configuration for the wireless communications network 100 may be needed. Therefore, the optimization node 110 estimates a configuration for optimizing the network performance. The configuration comprises one or more parameters for restraining the influence of the performance degradation. The configuration may comprise parameters related to physical changes in the wireless communications network 100. So, in some embodiments, the estimated configuration further comprises any one or more out of: adding a base station 130 to the wireless communications network 100, changing location of the base station 130, e.g. the first base station 131 and/or the second base station 132, adding, such as e.g. connecting, an antenna to one the base station 130, e.g. the first base station 131 and/or the second base station 132, and changing direction of one or more antennas comprised in the one or more base stations 130. An antenna comprised in the base station 130 when used herein may mean e.g. an antenna connected to and/or controlled by the base station 130. Physical changes when used herein may mean changes in the real environment, i.e. changes requiring e.g. the movement of, or changes to, physical objects. The configuration may further, or alternatively, comprise parameters not related to physical changes, such as parameters related to e.g. transmission power, MIMO settings and/or scheduling priorities. The estimated configuration may comprise parameters related to wireless device, such as the wireless device 120, operating in the wireless communications network. E.g. the estimated configuration may further comprise changing location of stationary wireless devices, such as e.g. the wireless device 120. Additionally, or alternatively, the estimated configuration may comprise changing location, such as moving as change position of, physical objects in blocking transmissions in the wireless communications network 100.

Action 205. The optimization node 110 evaluates the estimated configuration by performing at least one of a first and a second action for optimizing network performance, taking the estimated configuration into account. In other words, the optimization node 110 applies the estimated configuration and evaluates, such as checks, whether the performance of the wireless communications network 100 meets the performance criteria in order to optimize the performance o the wireless communications network 100. The evaluation may be performed in a simulated environment before applying the estimated configuration in the wireless communications network 100. The first and second actions may comprise one or more respective steps to be performed by the optimization node 110. The first action may comprise e.g. the following steps:
A1-1. Configure the one or more base station in accordance with the estimated configuration.
A1-2. Obtain further measurement data related to the performance of the wireless communications network 100. The further measurement data comprises location information associated to the measurement data.
A1-3. Update the generated coverage map. The update may be based on the obtained further measurement data.
A1-4. Evaluate the estimated configuration based on the updated coverage map. The evaluation may comprise determining whether or not the estimated configuration restrains the performance degradation in relation to the performance criteria.

The second action may comprise e.g. the following steps:
A2-1. Simulate the operation of the wireless communications network 100. The simulation may be based on the estimated configuration and historical data, such as e.g. historical measurement data.
A2-2. Update the generated coverage map. The update may be based on simulated measurement data obtained from the simulation.
A2-3. Evaluate the estimated configuration. The evaluation may comprise determining whether or not the estimated configuration restrains the performance degradation in relation to the performance criterium.
A2-4. Perform, in accordance with the estimated configuration, any one or more out of: adding a base station 130 to the wireless communications network, changing location of a base station 130, adding an antenna to the base station 130, e.g. the first base station 131 and/or the second base station 132, and changing direction of one or more antennas comprised in the one or more base stations 130.

In order to optimize the performance of the communications network 100, the optimization node 100 may perform one or both the first and second action. The optimization node 100 may determine which one of the first and second action to perform, or determine to perform both the first and second actions, based on the estimated configuration. As an example, when the estimated configuration does not comprise parameters related to physical changes of the wireless communications network 100, the optimization node 110 may determine to perform only the first action. As another example, when the estimated configuration does comprise parameters related physical changes of the wireless communications network 100, the optimization node 110 may determine to perform second action, in order to evaluate the estimated configuration, before performing the first action, where the estimated configuration is used to configure the one or more base stations 110. In some embodiments, evaluating the estimated configuration further comprises repeating any of Actions 201-205 in order to optimizes the performance of the wireless communications network 100. In other words, optimizing the performance of the wireless communications network may comprise an iterative process.

Embodiments mentioned above will now be further described and exemplified. The text below is applicable to and may be combined with any suitable embodiment described above.

Performance metrics, such as measurement data, may be collected, such as obtained, from the network side, such as e.g. the base station 130, or from measurements from UE side, such as e.g. the wireless device 120. Metrics collected from the stationary wireless devices 120 are inherently localized, while metrics collected from non-stationary wireless devices 120 devices need to be combined with location information, e.g. by known, or pre-defined, drive routes or by other means of localization related to the metrics E.g. the measurement data obtained by the optimization node 110, may comprise the localization information. There may also be specific wireless devices used, e.g. drones, such as unmanned aerial vehicles and/or or automated guided vehicles, to perform drive test and collect measurements combined with localization information. Two synchronized drones may build, such as generate, frequency band specific maps, such as the generated coverage map, when one drone is equipped with translation antenna and another drone with a receiving antenna. In this case path loss and reflections may be tested for all elements potentially blocking line of sight in the area. Alternatively, performance metrics may be derived by calculations and/or simulations in a software, e.g. in the optimization node 110 or in an additional node. The additional node may provide such as send, the performance metrics, such as measurements data, the optimization node 110.

Different signal characteristics may be visualized in Augmented Reality (AR) glasses in form of scatterplot, such as e.g. flying dots of different colors, visualized radio waves and/or rays from base stations, coloring as a heat-map depending on signal characteristics. The scatterplot may e.g. be the generated three dimensional coverage map. Rays may also reflect from obstacles, such as blocking elements, which may also be shown. Further, e.g. visual advices, such as recommendations, for placement of wireless devices and/or base stations, e.g. in form of a sphere of an estimated best position, such as location. A person performing network optimization may move objects, wireless devices 120, such as stationary wireless devices 120, and/or base stations 130 in real environment taking visual advises, such as recommendations, from visualized data points in the AR glasses. This advice module may signalize, such as e.g. point to or indicate, a location, base station 130 and/or wireless device 120 where a problem is detected, e.g. degraded performance, a coverage hole, a device with low signal quality. Once starting to solve the problem, the advice module may give, such as provide, further suggestions e.g. advices and/or recommendations, on how the problem may be solved. E.g. it may be suggested the best position of the base stations 130, changed and/or updated transmission parameters, e.g. without affecting coverage and/or performance elsewhere or creating new coverage holes. The advice module may be the optimization node 110.

According to an example, a tool for calculation of signal characteristics may react on changes in real environment and update data points, e.g. in the scatterplot or the generated coverage map, in real-time or with some reasonable delay. The updated data points may e.g. be measured, simulated, e.g. based on network characteristics and legacy measurements, or a combination of both. The calculation tool may be the optimization node 110. Or it may be another node, the calculation may subsequently by provided, such as sent, to the optimization node 110.

According to another example, the tool for calculation of signal characteristics may use a digital twin representation of the real environment.

According to another example, network optimization may be performed in a virtual 3D environment, such as e.g. a digital twin representation. The scatterplot, such as the generated coverage map, may be visualized in Virtual Reality (VR) glasses together with the digital twin representation of the real environment. When virtually moving within space and performing changes, the changes may immediately be considered to update signal data points, e.g. in the visualized scatterplot or coverage map. One or more changes may be tried until the optimal configuration and/or positions, such as locations, of wireless devices 120, base stations 130 and other objects within simulated space is achieved. In the end optimized design, such as configuration, may be implemented in a real environment.

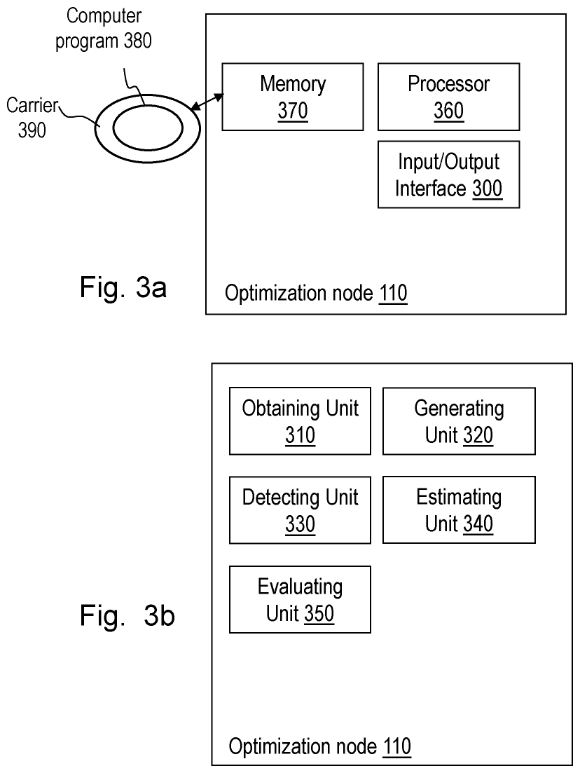

To perform the method actions above, an optimization node 110 configured to optimize network performance in a wireless communications network 100. The wireless communications network 100 is adapted to comprise one or more base stations 130. The one or more base stations 130 are adapted to provide radio coverage in the wireless communications network 100. The optimization node 110 may comprise an arrangement depicted in FIGS. 3a and 3b.

The optimization node 110 may comprise an input and output interface 300 configured to communicate with base stations such as the base stations 130, wireless devices such as the wireless device 120, and other network nodes in the wireless communications network 100. The input and output interface 300 may comprise a wireless receiver (not shown) and a wireless transmitter (not shown).

The optimizing node 110 is further be configured to, e.g. by means of an obtaining unit 310 in the optimizing node 110, obtain measurement data adapted to be related to the performance of the wireless communications network 100. The measurement data is adapted to comprise location information associated to each respective measurement in the measurement data. The measurement data may further be adapted to comprise data related to any one or more out of: Latency of transmissions, bitrate of transmissions, network capacity, and retransmission of data.

The optimizing node 110 is further be configured to, e.g. by means of a generating unit 320 in the optimizing node 110, generate the three-dimensional coverage map adapted to be based on the obtained measurement data. The coverage map is adapted to indicating the performance of the wireless communications network 100 in the area covered by the coverage map.

The optimizing node 110 is further be configured to, e.g. by means of a detecting unit 330 in the optimizing node 110, detect, based on the generated coverage map, one or more locations suffering from the degraded performance in relation to the performance requirement. The performance requirement is adapted to comprise any one or more out of: a latency requirement, a bit-rate requirement, a capacity requirement, a retransmission requirement, and a signal strength requirement.

The optimizing node 110 is further be configured to, e.g. by means of an estimating unit 340 in the optimizing node 110, estimate the configuration adapted to optimize the network performance, taking the performance requirement into account. The configuration is adapted to comprise one or more parameters adapted to restrain the influence of the performance degradation. The estimated configuration may further be adapted to comprise any one or more out of: add a base station 130 to the wireless communications network 100, change location of a base station 130, add an antenna to a base station 130, and change direction of one or more antennas comprises in the one or more base stations 130.

The optimizing node 110 is further be configured to, e.g. by means of an evaluating unit 350 in the optimizing node 110, evaluate the estimated configuration by performing at least one of the first and the second action adapted to optimize network performance, taking the estimated configuration and performance requirement into account into account. The first action may be adapted to comprise:
configure the one or more base station in accordance with the estimated configuration,
obtain further measurement data adapted to be related to the performance of the wireless communications network 100. The further measurement data is adapted to comprise location information associated to the measurement data.
update the generated coverage map. The update is adapted to be based on the obtained further measurement data, and
evaluate the estimated configuration based on the updated coverage map. The optimization node 110 is further configured to evaluate the estimated configuration by determining whether or not the estimated configuration restrains the performance degradation in relation to the performance criteria.

The second action may be adapted to comprise:
simulate the operation of the wireless communications network 100. The simulation is adapted to be based on the estimated configuration and historical data.
update the generated coverage map. The update is adapted to be based on simulated measurement data obtained from the simulation,
evaluate the estimated configuration. The optimization node 110 is further configured to evaluate the estimated configuration by determining whether or not the estimated configuration restrains the performance degradation in relation to the performance criteria, and
perform, in accordance with the estimated configuration, any one or more out of: add a base station 130 to the wireless communications network 100, change location of a base station 130, add an antenna to a base station 130, and change direction of one or more antennas adapted to be comprised in the one or more base stations 130.

The embodiments herein may be implemented through a respective processor or one or more processors, such as the processor 360 of a processing circuitry in the optimization node 110 depicted in FIG. 3a, together with respective computer program code for performing the functions and actions of the embodiments herein. The computer program code mentioned above may also be provided as a computer program product, for instance in the form of a data carrier carrying computer program code for performing the embodiments herein when being loaded into the optimization node 110. One such carrier may be in the form of a CD ROM disc. It is however feasible with other data carriers such as a memory stick. The computer program code may furthermore be provided as pure program code on a server and downloaded to the optimization node 110.

The optimization node 110 may further comprise a memory 370 comprising one or more memory units. The memory 370 comprises instructions executable by the processor in optimization node 110. The memory 370 is arranged to be used to store e.g. actions, indication, configurations, parameters, performance requirements, measurement data, estimations, evaluations, coverage maps, data, information, thresholds and applications to perform the methods herein when being executed in the optimization node 110.

In some embodiments, a computer program 380 comprises instructions, which when executed by the respective at least one processor 360, cause the at least one processor 360 of the optimization node 110 to perform the actions above.

In some embodiments, a respective carrier 390 comprises the respective computer program 380, wherein the carrier 390 is one of an electronic signal, an optical signal, an electromagnetic signal, a magnetic signal, an electric signal, a radio signal, a microwave signal, or a computer-readable storage medium.

Those skilled in the art will appreciate that the units in the optimization node 110 described above may refer to a combination of analog and digital circuits, and/or one or more processors configured with software and/or firmware, e.g. stored in the optimization node 110, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

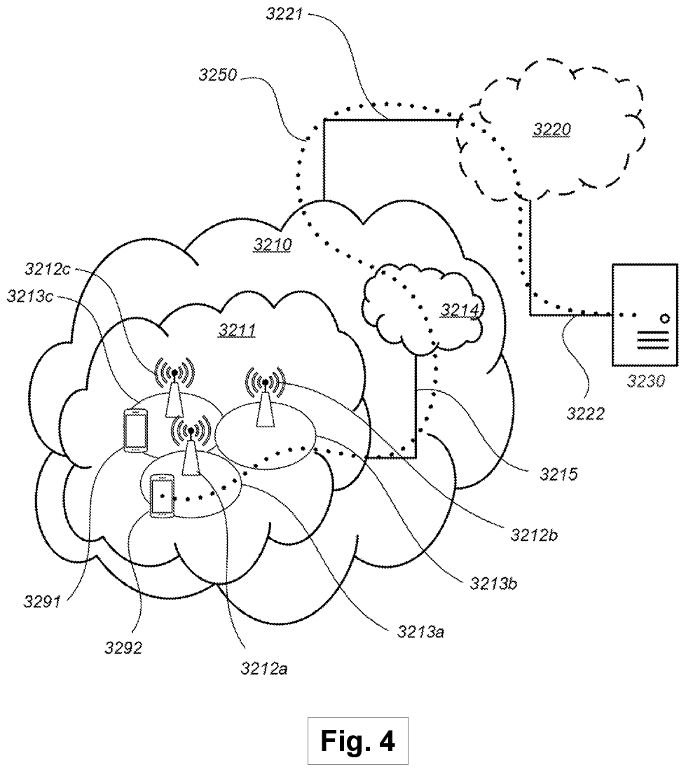

With reference to FIG. 4, in accordance with an embodiment, a communication system includes a telecommunication network 3210 such as the wireless communications network 100, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the base stations 130 and/or the optimization node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the wireless device 120 such as a Non-AP STA 3291 located in coverage area 3213c is configured to wirelessly connect to, or be paged by, the corresponding base station 3212c. A second UE 3292 e.g. the wireless device 120 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 4 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

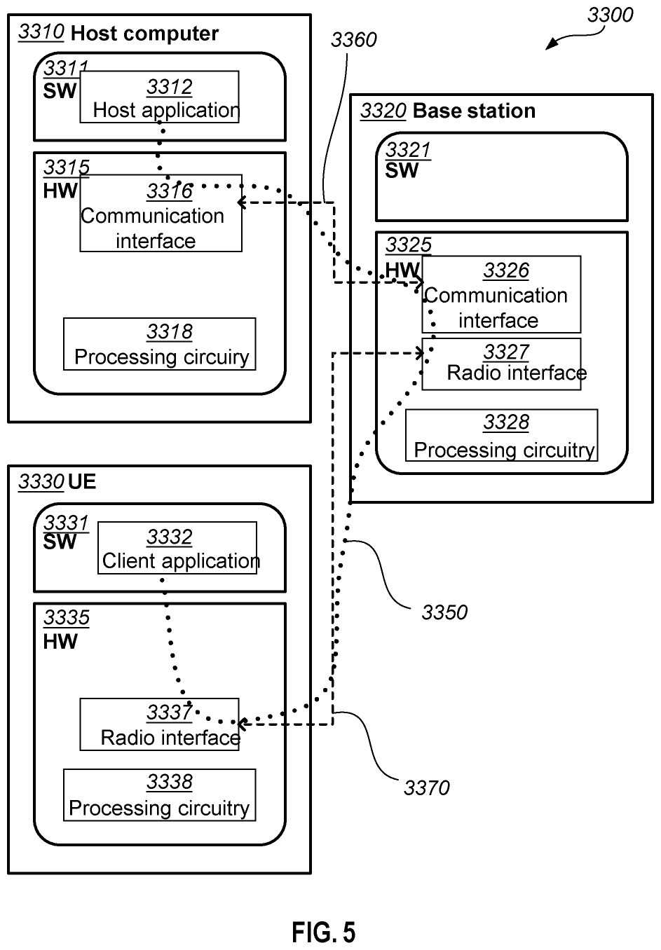

Example implementations, in accordance with an embodiment, of the UE, base station and host computer discussed in the preceding paragraphs will now be described with reference to FIG. 5. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 5) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 5 may be identical to the host computer 3230, one of the base stations 3212a, 3212b, 3212c and one of the UEs 3291, 3292 of FIG. 4, respectively. This is to say, the inner workings of these entities may be as shown in FIG. 5 and independently, the surrounding network topology may be that of FIG. 4.

In FIG. 5, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

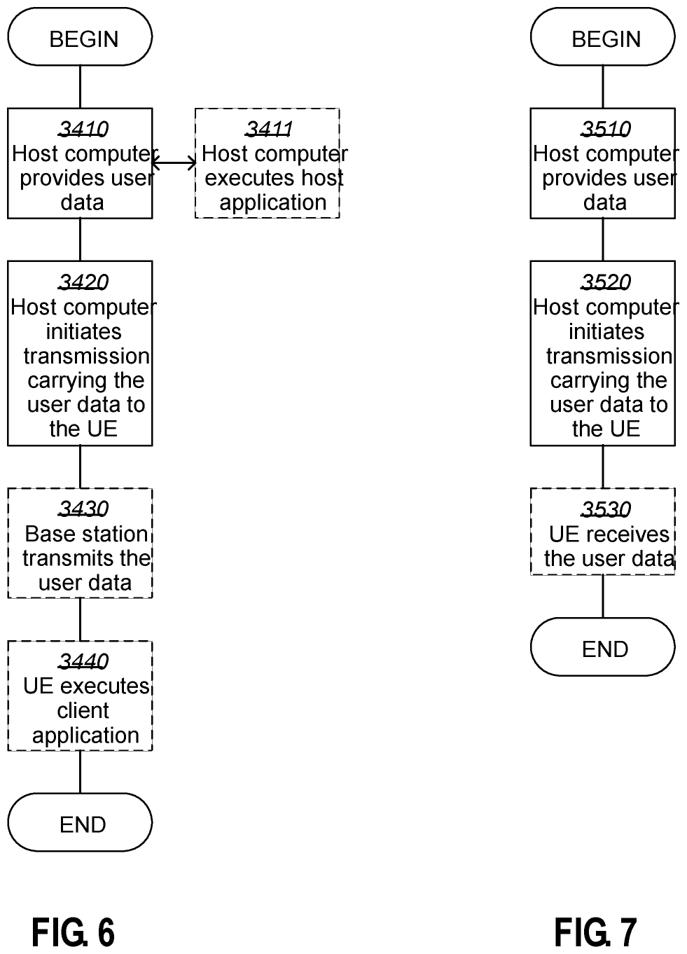

FIG. 6 is a flowchart illustrating a method implemented in a communication system, in accordance with one embodiment. The communication system includes a host computer, a base station such as the network node 112, and a UE such as the UE 120, which may be those described with reference to FIG. 4 and FIG. 5. For simplicity of the present disclosure, only drawing references to FIG. 6 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 7 is a flowchart illustrating a method implemented in a communication system, in accordance with one embodiment. The communication system includes a host computer, a base station such as an AP STA, and a UE such as a Non-AP STA which may be those described with reference to FIG. 4 and FIG. 5. For simplicity of the present disclosure, only drawing references to FIG. 7 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

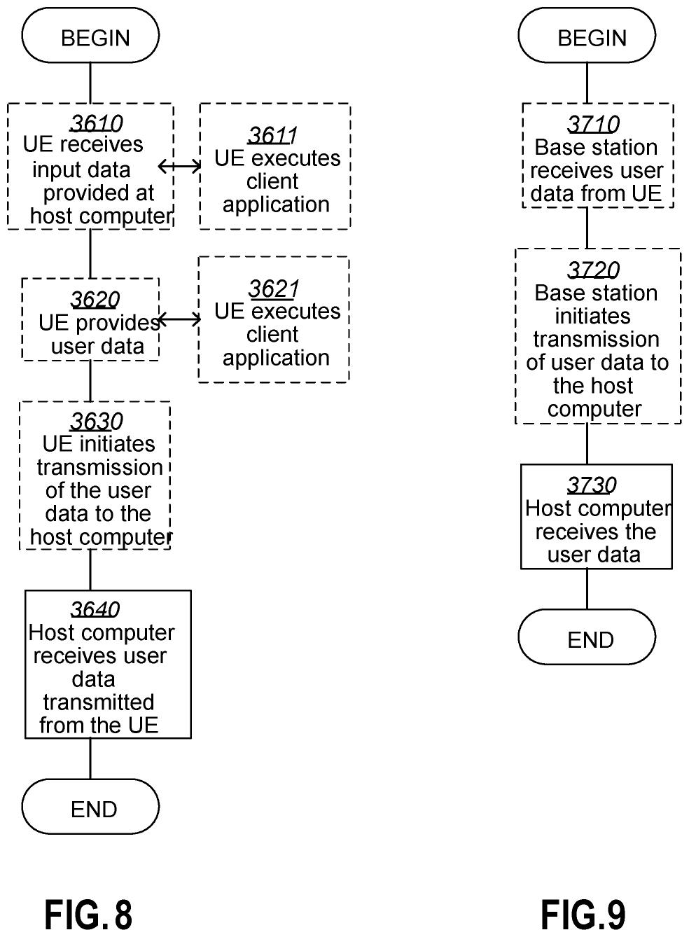

FIG. 8 is a flowchart illustrating a method implemented in a communication system, in accordance with one embodiment. The communication system includes a host computer, a base station such as an AP STA, and a UE such as a Non-AP STA which may be those described with reference to FIG. 4 and FIG. 5. For simplicity of the present disclosure, only drawing references to FIG. 8 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 9 is a flowchart illustrating a method implemented in a communication system, in accordance with one embodiment. The communication system includes a host computer, a base station such as an AP STA, and a UE such as a Non-AP STA which may be those described with reference to FIG. 4 and FIG. 5. For simplicity of the present disclosure, only drawing references to FIG. 9 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by an optimization node for optimizing network performance in a wireless communications network comprising one or more base stations, which one or more base stations provides radio coverage in the wireless communications network, the method comprising:
obtaining measurement data related to the performance of the wireless communications network, which measurement data comprises location information associated to the measurement data;
generating a three-dimensional coverage map based on the obtained measurement data, the coverage map indicating the performance of the wireless communications network in the area covered by the coverage map;
detecting, based on the generated coverage map, one or more locations suffering from a degraded performance in relation to a performance requirement;
estimating a configuration for optimizing the network performance, taking the performance requirement into account, which configuration comprises one or more parameters for restraining the influence of the performance degradation; and
evaluating the estimated configuration by performing at least one of a first and a second action for optimizing network performance, taking the estimated configuration and performance requirement into account.

2. The method according to claim 1, wherein the first action comprises:
configuring the one or more base station in accordance with the estimated configuration;
obtaining further measurement data related to the performance of the wireless communications network, which further measurement data comprises location information associated to the measurement data;
updating the generated coverage map, which update is based on the obtained further measurement data; and
evaluating the estimated configuration based on the updated coverage map, wherein the evaluating comprises determining whether or not the estimated configuration restrains the performance degradation in relation to the performance criteria.

3. The method according to claim 1,
wherein the estimated configuration further comprises any one or more out of:
adding a base station to the wireless communications network;
changing location of a base station;
adding an antenna to a base station; and
changing direction of one or more antennas comprises in the one or more base stations.

4. The method according to claim 3, wherein the second action comprises:
simulating the operation of the wireless communications network, which simulation is based on the estimated configuration and historical data;
updating the generated coverage map, which update is based on simulated measurement data obtained from the simulation;
evaluating the estimated configuration based on the update coverage map, wherein the evaluating comprises determining whether or not the estimated configuration restrains the performance degradation in relation to the performance criteria; and
performing, in accordance with the estimated configuration, any one or more out of:
adding a base station to the wireless communications network;
changing location of a base station;
adding an antenna to a base station; and
changing direction of one or more antennas comprised in the one or more base stations.

5. The method according to claim 1, wherein the performance requirement comprises any one or more out of:
a latency requirement;
a bit-rate requirement;
a capacity requirement;
a retransmission requirement; and
a signal strength requirement.

6. The method according to claim 1, wherein the measurement data further comprises data related to any one or more out of:
latency of transmissions;
bitrate of transmissions;
network capacity; and
retransmission of data.

7. A computer storage medium storing a computer program comprising instructions, which when executed by a processor, causes the processor to perform actions for optimizing network performance in a wireless communications network comprising one or more base stations, which one or more base stations provides radio coverage in the wireless communications network, the actions comprising:
obtaining measurement data related to the performance of the wireless communications network, which measurement data comprises location information associated to the measurement data;
generating a three-dimensional coverage map based on the obtained measurement data, the coverage map indicating the performance of the wireless communications network in the area covered by the coverage map;
detecting, based on the generated coverage map, one or more locations suffering from a degraded performance in relation to a performance requirement;
estimating a configuration for optimizing the network performance, taking the performance requirement into account, which configuration comprises one or more parameters for restraining the influence of the performance degradation; and
evaluating the estimated configuration by performing at least one of a first and a second action for optimizing network performance, taking the estimated configuration and performance requirement into account.

8. (canceled)

9. An optimization node configured to optimize network performance in a wireless communications network comprising one or more base stations, which one or more base stations are adapted to provide radio coverage in the wireless communications network, which optimization node is further configured to:
obtain measurement data adapted to be related to the performance of the wireless communications network, which measurement data is adapted to comprise location information associated to each respective measurement in the measurement data;
generate a three-dimensional coverage map adapted to be based on the obtained measurement data, the coverage map is adapted to indicating the performance of the wireless communications network in the area covered by the coverage map;
detect, based on the generated coverage map, one or more locations suffering from a degraded performance in relation to a performance requirement;
estimate a configuration adapted to optimize the network performance, taking the performance requirement into account, which configuration is adapted to comprise one or more parameters adapted to restrain the influence of the performance degradation; and
evaluate the estimated configuration by performing at least one of a first and a second action adapted to optimize network performance, taking the estimated configuration performance requirement into account into account.

10. The optimization node according to claim 9, wherein the first action comprises:
configuring the one or more base station in accordance with the estimated configuration;
obtaining further measurement data adapted to be related to the performance of the wireless communications network, which further measurement data is adapted to comprise location information associated to the measurement data;
updating the generated coverage map, which update is adapted to be based on the obtained further measurement data; and
evaluating the estimated configuration based on the updated coverage map, wherein optimization node is further configured to evaluate the estimated configuration by determining whether or not the estimated configuration restrains the performance degradation in relation to the performance criteria.

11. The optimization node according to claim 9, wherein the estimated configuration further comprises any one or more out of:
adding a base station to the wireless communications network;
changing location of a base station;
adding an antenna to a base station; and
changing direction of one or more antennas comprises in the one or more base stations.

12. The optimization node according to claim 11, wherein the second action comprises:
simulating the operation of the wireless communications network, which simulation is adapted to be based on the estimated configuration and historical data;
updating the generated coverage map, which update is adapted to be based on simulated measurement data obtained from the simulation;
evaluating the estimated configuration based on the update coverage map, wherein optimization node is further configured to evaluate the estimated configuration by determining whether or not the estimated configuration restrains the performance degradation in relation to the performance criteria; and
performing, in accordance with the estimated configuration, any one or more out of:
adding a base station to the wireless communications network;
changing location of a base station;
adding an antenna to a base station; and
changing direction of one or more antennas adapted to be comprised in the one or more base stations.

13. The optimization node according to claim 9, wherein the performance requirement comprises any one or more out of:
a latency requirement;
bit-rate requirement;
a capacity requirement;
retransmission requirement; and
a signal strength requirement.

14. The optimization node according to claim 9, wherein the measurement data further comprises data related to any one or more out of:
latency of transmissions;
bitrate of transmissions;
network capacity; and
retransmission of data.

15. The method according to claim 2, wherein the estimated configuration further comprises any one or more out of:
adding a base station to the wireless communications network;
changing location of a base station;
adding an antenna to a base station; and
changing direction of one or more antennas comprises in the one or more base stations.

16. The method according to claim 15, wherein the second action comprises:
simulating the operation of the wireless communications network, which simulation is based on the estimated configuration and historical data;
updating the generated coverage map, which update is based on simulated measurement data obtained from the simulation;
evaluating the estimated configuration based on the update coverage map, wherein the evaluating comprises determining whether or not the estimated configuration restrains the performance degradation in relation to the performance criteria; and
performing, in accordance with the estimated configuration, any one or more out of:
adding a base station to the wireless communications network;
changing location of a base station;
adding an antenna to a base station; and
changing direction of one or more antennas comprised in the one or more base stations.

17. The method according to claim 2, wherein the performance requirement comprises any one or more out of:
a latency requirement;
a bit-rate requirement;
a capacity requirement;
a retransmission requirement; and
a signal strength requirement.

18. The method according to claim 2, wherein the measurement data further comprises data related to any one or more out of:
latency of transmissions;
bitrate of transmissions;
network capacity; and
retransmission of data.

19. The optimization node according to claim 10, wherein the estimated configuration further comprises any one or more out of:
adding a base station to the wireless communications network;
changing location of a base station;
adding an antenna to a base station; and
changing direction of one or more antennas comprises in the one or more base stations.

20. The optimization node according to claim 19, wherein the second action comprises:
simulating the operation of the wireless communications network, which simulation is adapted to be based on the estimated configuration and historical data;
updating the generated coverage map, which update is adapted to be based on simulated measurement data obtained from the simulation;
evaluating the estimated configuration based on the update coverage map, wherein optimization node is further configured to evaluate the estimated configuration by determining whether or not the estimated configuration restrains the performance degradation in relation to the performance criteria; and
performing, in accordance with the estimated configuration, any one or more out of:
adding a base station to the wireless communications network;
changing location of a base station;
adding an antenna to a base station; and
changing direction of one or more antennas adapted to be comprised in the one or more base stations.

21. The optimization node according to claim 10, wherein the performance requirement comprises any one or more out of:
a latency requirement;
bit-rate requirement;
a capacity requirement;
retransmission requirement; and
a signal strength requirement.
